(19) United States
(12) Patent Application Publication
(10) Pub. No.: US 2002/0082046 A1
(43) Pub. Date: Jun. 27, 2002

(54) Telephony device for providing audio telecommunication between a user and a computer or over a PSTN

(76) Inventors: Arthur Stanley Peters III, Ventura, CA (US); Edward John Peters, Ventura, CA (US); Jerome Cole, Oxnard, CA (US); Ronald Wayne Ferril, Ventura, CA (US)

Correspondence Address: TOM ODGERS, 19808 Ahwanee Lane, Northridge, CA, 91326, US

(21) Appl. No.: 09/976,633

(22) Filed: Oct. 12, 2001

Related U.S. Application Data
(60) Provisional application No. 60/240,711, filed on Oct. 12, 2000.

(51) Int. Cl. H04Q 7/20

(52) U.S. Cl. 455/556; 455/465

(57) ABSTRACT

The present invention is embodied in a telephony device, which can be a cordless handset, for providing two-way and or one-way communication with other audio devices, while retaining the ability to serve as a standard cordless telephone device over a public switched telephone network (PSTN), with the capability of performing both functions simultaneously. The invention provides the user with a cordless (RF) radio frequency communication device that interfaces with a wide variety of audio components and or computer hardware and or software, while retaining the ability to be used simultaneously as a cordless and or hands free telephone. Accordingly, the invention may be in active communication with, but not limited to, a computer, laptop computer or notebook, palm device or Web TV device and or external audio devices.

### FIELD OF THE INVENTION

The present invention relates to the fields of telephonic communications and computer telephony. More precisely, the present invention relates to a telephony device, such as a cordless handset, for providing two-way and or one-way communication with other audio devices, while retaining the ability to serve as a standard cordless telephone device over a public switched telephone network (PSTN), with the capability of performing both functions simultaneously.

### BACKGROUND OF THE INVENTION

Cordless or wireless communications may include a computer, laptop computer or notebook, palm device or Web TV device. With the huge popularity and movement in consumer usage in Internet telephony, areas such as voice recognition, home automation (voice commands), Internet navigation, voice controlled computer programs, online instant messengers and online voice mail programs are being incorporated.

Cordless telephones for example, have become very popular in the consumer marketplace. An example of one is disclosed in U.S. Pat. No. 4,591,661. The invention is a cordless telephone transceiver having a broadcast RF receiver. This invention is designed to connect to PSTN public switched telephone network and has no capability to connect externally to any other audio device.

A wide selection of cordless telephones, indicate the consumer's interest in communication mobility. Cordless telephones operate by transmitting an RF radio frequency between a handset and or headset and a base unit, which is connected to a PSTN. The typical handset is equipped with a number pad, for dialing numbers, and a ringer so the user can send and receive, initiate and terminate telephone calls. Other functionality may be incorporated into the terminate telephone calls. Other functionality may be incorporated into the handset and or headset, for example, communication with the base or a paging function initiated from the base to help find the handset or headset. Using RF as its communication link enables the user to roam from room to room and even outside while using the phone. The user is limited to a certain reception area. The consumer market has become very accustomed to the convenience of these devices, and in turn, very familiar with their interface.

A large percentage of the end user base already use a wired microphone, and or, wired speakers and or, a corded microphone headset. Consequently, software manufactures design their service or product to be pre-configured for these devices. The designs utilize the standard microphone jack or input jack or audio input jack and or speaker jack or output jack or speaker out jack of most audio devices. If the end user was already using a wired or cordless microphone, and or, wired or cordless speakers and or, increasingly popular, corded or cordless (wireless) microphone headset, devices could plug directly into the same jacks that they were already utilized. Other connections are possible and include but are not limited to, USB (universal serial bus) connection, RF (radio frequency) transmitter and or receiver, IR (infrared) transmitter and or receiver, or any other cabled or cordless connections.

There are many different computer hardware platforms and operating systems. If a nonproprietary interface will work on PC compatible systems as well as, but not limited to, Macintosh computers it will work on any multimedia computer that has the capability of audio input and or audio output (to be fully functional both are required). A device may require software to be loaded in order for it to operate with many different audio devices, or computers with sound cards, audio equipment such as audio recorders and audio players, other telephony equipment or any device that has an audio input and or audio output.

Therefore what is required is a useful tool that would operate in an already successful market and have at its disposal a way to make existing products even more useful than they already were. What is further required is a less constrictive and less cumbersome method of audio input and or output to a computer.

A design that will work as a standard cordless telephone as well as a full duplex communication device is required that will interface with a typical sound card enabled computer with a standard Internet connection, and would have the ability to conduct Internet enabled telephone calls using third party software. In addition, what is required is a device that can host an Internet call and a Standard Telephone Call, simultaneously, and can conference call between the Internet Call and the Standard Telephone Call or put one or the other on hold.

### SUMMARY OF THE INVENTION

To overcome the limitations in the prior art described above, and to overcome other limitations that will become apparent upon reading and understanding the present specification, the present invention is embodied in a telephony device, which can be a cordless handset, for providing two-way and or one-way communication with other audio devices, while retaining the ability to serve as a standard cordless telephone device over a public switched telephone network (PSTN), with the capability of performing both functions simultaneously.

The invention provides the user with a cordless (RF) radio frequency communication device that interfaces with a wide variety of audio components and or computer hardware and or software, while retaining the ability to be used simultaneously as a cordless and or hands free telephone.

Accordingly, the invention may be in active communication with, but not limited to, a computer, laptop computer or notebook, palm device or Web TV device and or external audio devices. Variations of the invention include the following.

Cordless sound input for use in place of a cabled microphone. The microphone from the handset could be used, or a headset could be plugged into the handset and become hands free Cordless sound output can be used for listening to sound normally heard through external speakers and or pc speaker, stereo or mono headphones, etc. In addition to being a cordless communications device, it can operate as a regular corded or cordless telephone with all the normal features.

Computer telephony can be implemented with third party computer telephony products, for long distance phone calls in the U.S. and many other countries. Use the invention's full duplex cordless capabilities with third party software for making computer-to-computer phone calls and n computer to standard phones through public switch telephone network. Additionally, use the invention for checking your on-line voice mail messages. Use the invention with instant messenger services. Use all of these, with cordless freedom.

Voice recognition can be implemented with third party software for dictation purposes as well as using voice commands with third party software for controlling a computer by giving voice commands, surfing the Internet, giving a presentation to a large audience using a computer driven slide presentation on an LCD projector.

Home automation with third party software to control domestic applications through voice activation. Conference calling for conducting a standard telephone call. The call can be put on hold, then a computer telephony call can be initiated, and a button can be depressed for a three-way conference call. Telephone call recording for recording live telephone conversations with a telephone call recording feature, digital and or analog, which has audio input and recording capabilities. Examples include, but are not limited to, a computer hard drive, DAT recorder or standard tape recorder.

A telephone audio playback can be engaged in an active telephone call to include a secondary audio source into the conversation. For instance, during a telephone call, if the user were hooked to a multimedia computer, it would be possible to hear any sound that the computer was making. For example, during an active standard telephone call over a PSTN, a user may want to play a recorded voice mail message from their on line voice messaging service for the person to hear while they are on the telephone with them. This is possible by merely pushing the correct sequence of buttons, so that the secondary audio signal is connected, and then launching the audio file on the computer. It is also possible to adjust the volume of this signal from the computer. It is also possible to introduce the secondary audio signal from a multitude of other audio devices. These following examples include, but are not limited to, personal digital recorder player, compact disk player, DAT recorder & player, etc. It is also possible to connect additional devices simultaneously through the use of normal splitters, adaptors and or cables.

Cordless public address (PA) can be implemented when used in conjunction with the input of a capable audio device, such as but not limited to an audio amplifier & speakers and or audio receiver and speakers, the invention could be used as a PA public address system.

### BRIEF DESCRIPTION OF THE DRAWINGS

The present invention can be further understood by reference to the following description and attached drawings that illustrate the preferred embodiment. Other features and advantages will be apparent from the following detailed description of the preferred embodiment, taken in conjunction with the accompanying drawings, which illustrate, by way of example, the principles of the invention.

FIG. 1 shows a diagram of preferred embodiment in communication with a standard sound card equipped computer with Internet connection capabilities and typical third party software packages loaded.

FIG. 2 shows a diagram of another embodiment being utilized as a normal cordless phone over a (PSTN) public switched telephone network.

FIG. 3 shows a diagram of another embodiment being utilized as a normal cordless phone over a (PSTN) public switched telephone network.

FIG. 4 shows a diagram of an alternative embodiment of the present invention communicating with other audio signal devices.

FIG. 5 shows a diagram of the coupling device for the audio output or Base Line Out.

FIG. 6 shows a block diagram of a Base Line Out coupling device.

FIG. 7 shows a diagram of the audio input or Base Line In device.

FIG. 8 shows a diagram of the voltage regulator used by the coupling device.

### DETAILED DESCRIPTION OF THE PREFERRED EMBODIMENTS

In the following description of the invention, reference is made to the accompanying drawings, which form a part hereof, and in which is shown by way of illustration a specific example in which the invention may be practiced. It is to be understood that other embodiments may be utilized and structural changes may be made without departing from the scope of the present invention.

I. Introduction

The present invention is embodied in a system and method for a cordless handset to provide two-way and or one-way communication with other audio devices, while retaining the ability to serve as a standard cordless telephone device over a public switched telephone network (PSTN), with the capability of performing both functions simultaneously.

In general, the present invention provides a means for the user to work with a variety of audio devices, through an interface with a standard computer audio card; more precisely, a computer equipped audio card having the ability to send an audio signal out and as well as being able to accept an external audio signal from another source. This interface provides multiple options using the connection.

II. General Overview

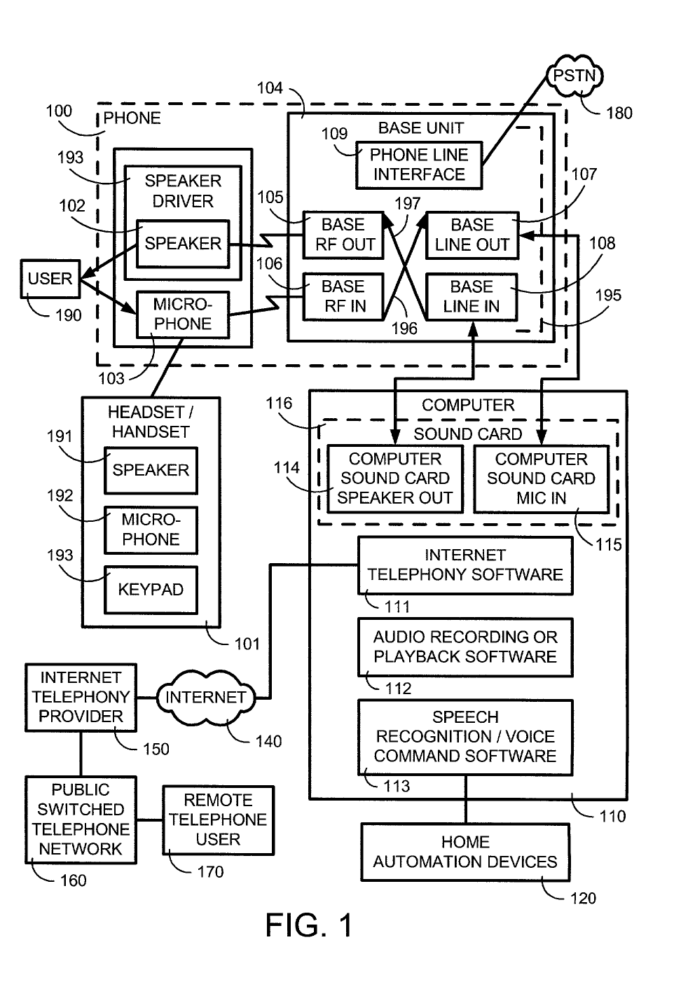

FIG. 1 shows a diagram of a preferred embodiment of the invention. A typical cordless phone 100 with intercom and conferencing capabilities, has two parts, a set 101 and a base unit 104. The base unit 104, has a speaker 102 and a microphone 103 that attaches to a phone line 109 and the set 101 which may be a headset or a handset communicating by RF. The system has an intercom mode that allows communication between the base 104 and the set 101. Also the device can conference between the base 104, the PSTN 180 and the set 101.

In the normal intercom mode, sound detected by the microphone 103 of the base 104 is transmitted to the speaker 191 of the set 091, and sound detected by the microphone 192 of the set 101 is transmitted to the speaker 102 of the base 104. A speaker driver 193 drives the speaker 102 in the base 104, and the microphone 103 is connected to a pre-amplifier. Audio signals in the phone 100 are re-routed so that the phone 100 audio input is enabled through the base line in 106 and audio output is enabled through base line out 107 connections.

When the phone 100 is in communication with the computer 110 through the computer sound card 116, the base line in 108 connection receives a signal from the audio output 114 of the computer sound card, and in turn the signal is directed through the microphone pre-amplifier and transmitted to the set 101 earpiece.

The base line out 107 receives its signal from the base speaker driver 193, and in turn the signal is sent to the microphone input 115 of the sound card 116. The signal is attenuated to a level appropriate for the proper input of the connecting device. When the base unit 104 is operating in Mode A, and the user 190 speaks into the set 101 microphone 192, the resultant audio signal is transmitted to the base in 106. From here the signal is routed 196 to the line out 107 and into the computer microphone 115.

Conversely, any audio signal produced by computer speaker out 114 is transmitted to line in 108 and then through 197 to the base out 105 and to the handset speaker 191. Audio, transmitted or received by the sound card 116, could be used, but not limited to, Internet telephony 111, audio recording/playback 112, or speech recognition/voice command 113.

Audio signals, sent and received from the base line in 108, and out 107, could be transmitted by the computer, using Internet telephony software 111, through the Internet 140 to an Internet telephony provider 150. The provider 150 could call a remote telephone user 170 through the PSTN 160. The result would be full duplex communication between the user 190 and the remote telephone user 170.

III. Details of the Components and Operation

In mode A, running audio recording software 112, would allow the user's voice to be recorded via the set 101. In addition, audio could be played back to the user 190 from the computer 110 through the set 101. Operating in mode A and running speech recognition/voice command 113 on the computer 110, would allow the user 190 to control the computer 110, or any other device attached to the computer 110, for example home automation devices 120, by audio.

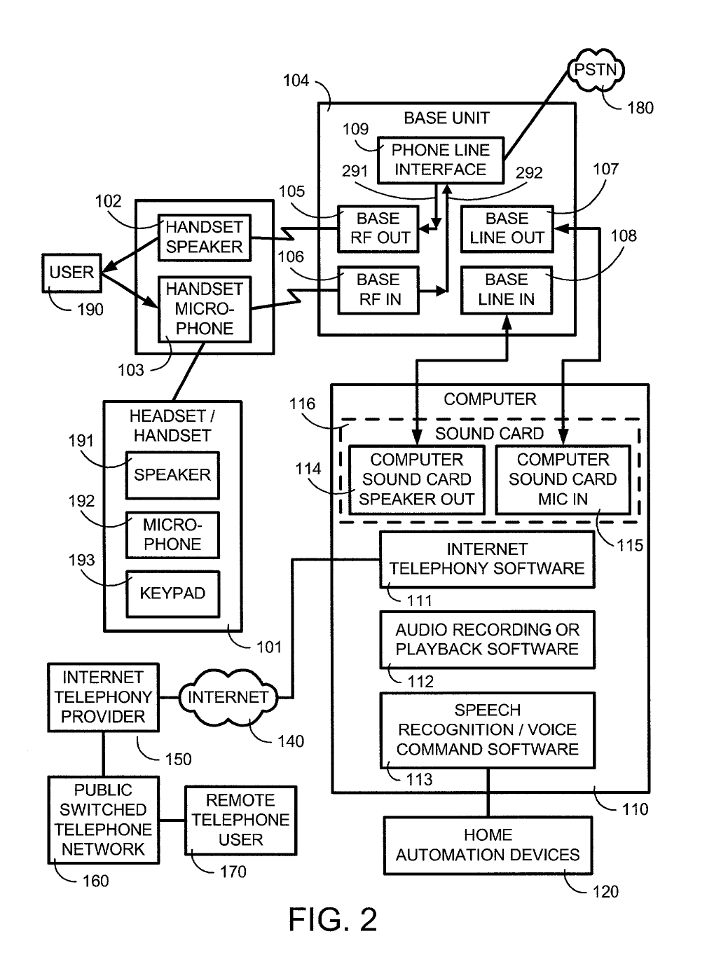

FIG. 2 shows a diagram of a preferred embodiment of the present invention in mode B. This mode allows the invention to operate as a standard cordless phone. The audio generated by the user 190 through the microphone 192 is transmitted via RF to the base unit's 104 reception circuitry, base in 106 and then through the phone line interface 109. Inbound audio from the phone line in 108 is transmitted to the base out 105 and thence via RF to the set speaker 191. Additionally DTMF tones can be generated to allow dialing of phone numbers.

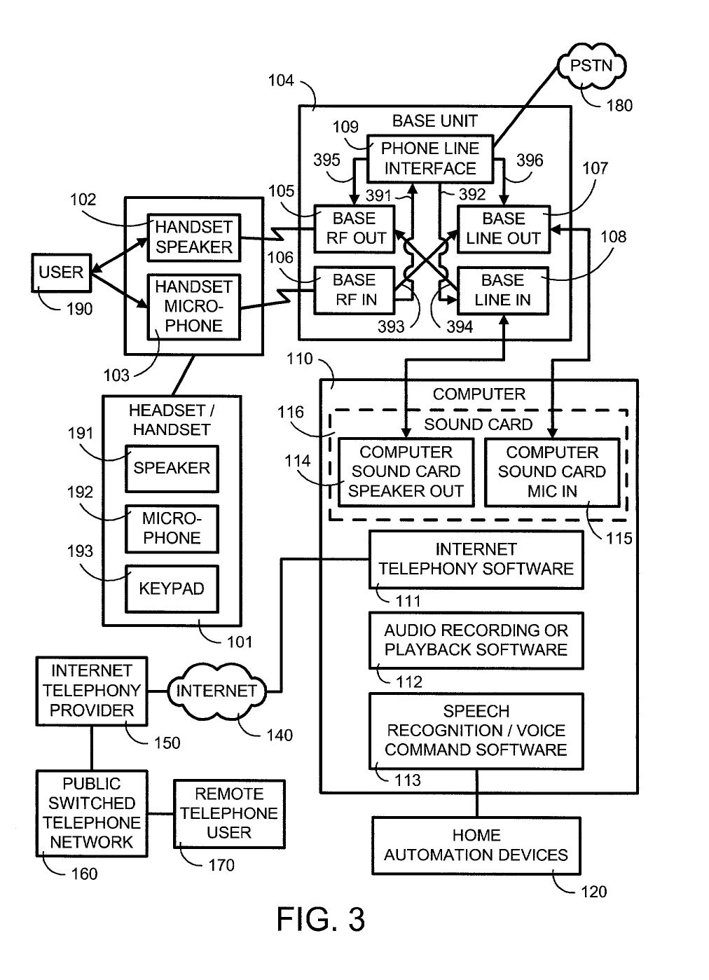

FIG. 3 shows a diagram of a preferred embodiment labeled mode C. In this mode the invention allows for communication with devices linked through the base unit's line in 108, line out 107, RF in 106, RF out 105, and the phone line. When the user 190 generates audio through the microphone 192, it is transmitted 391, 393, through the base in 106 to the phone line interface 109 and the line out 107.

When the audio is generated from the phone line interface 109, it is conducted 395, 396 to the base out 105 and the base line out 107. When audio is generated from the computers speaker 114, it is conducted to the base line in 108, and then via 392 to the phone line interface 109, and by 393 to the base RF out 105. From there it is transmitted to the set 101 for playback on the speaker 191. This allows full duplex conferencing between the computer 110 and the user 190, an Internet telephony caller 170 and a regular PSTN caller 181. Recordings or plays back (through 112) of telephone calls between users could be made.

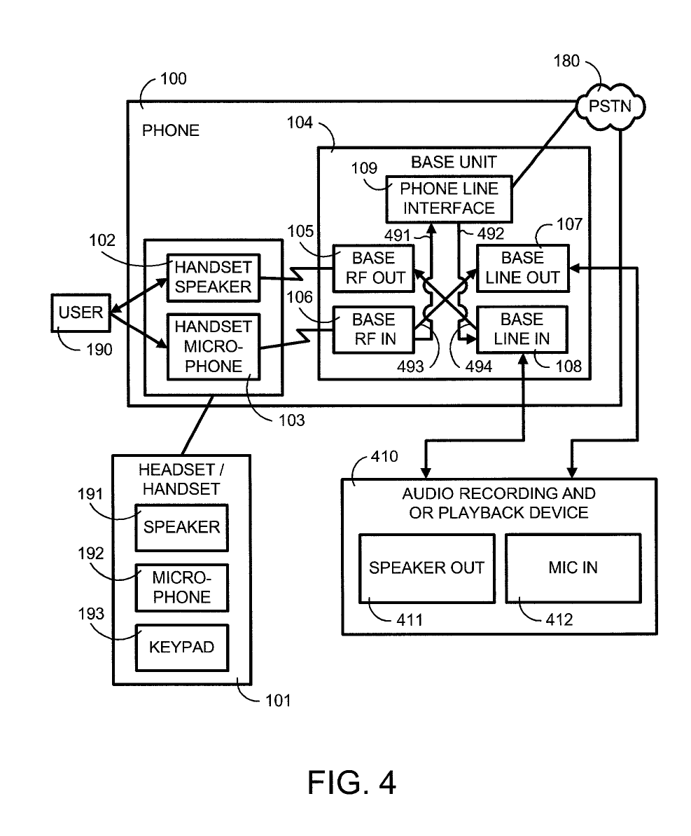

FIG. 4 shows a diagram of a secondary embodiment of the invention. The phone 100 has the capacity to operate with standard audio recording and playback devices 410, as well as to act as a telephone. This means that conversations could be recorded and played back, playback recorded audio into a telephone conversation, or play a telephone conversation live over an audio sound system. The set 101 could be used to record the user's 190 voice for purposes such as dictation.

II. Working Example

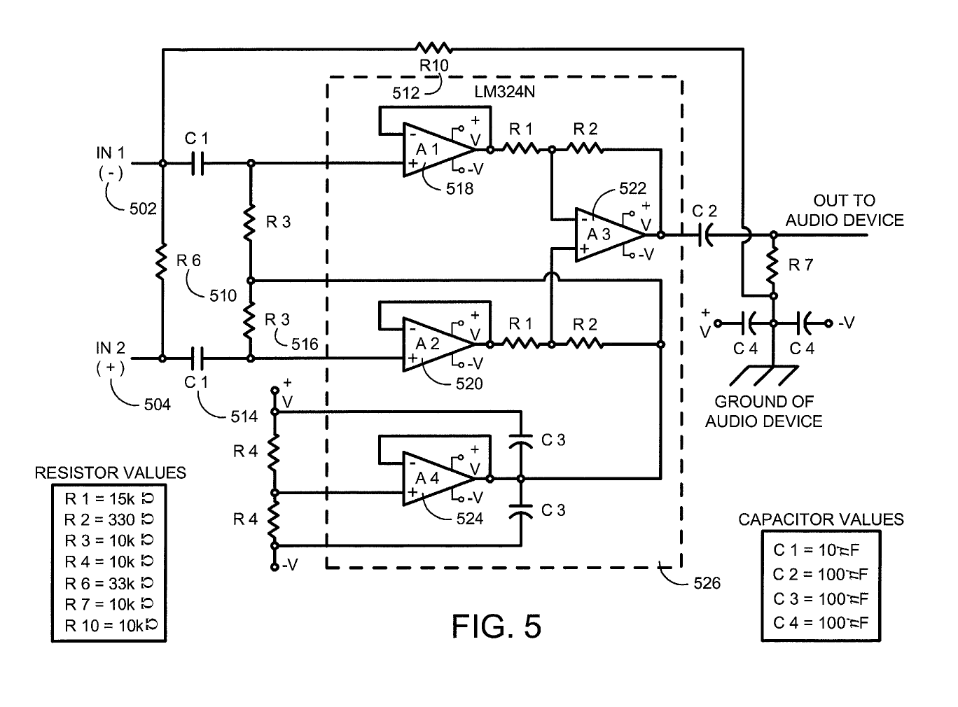

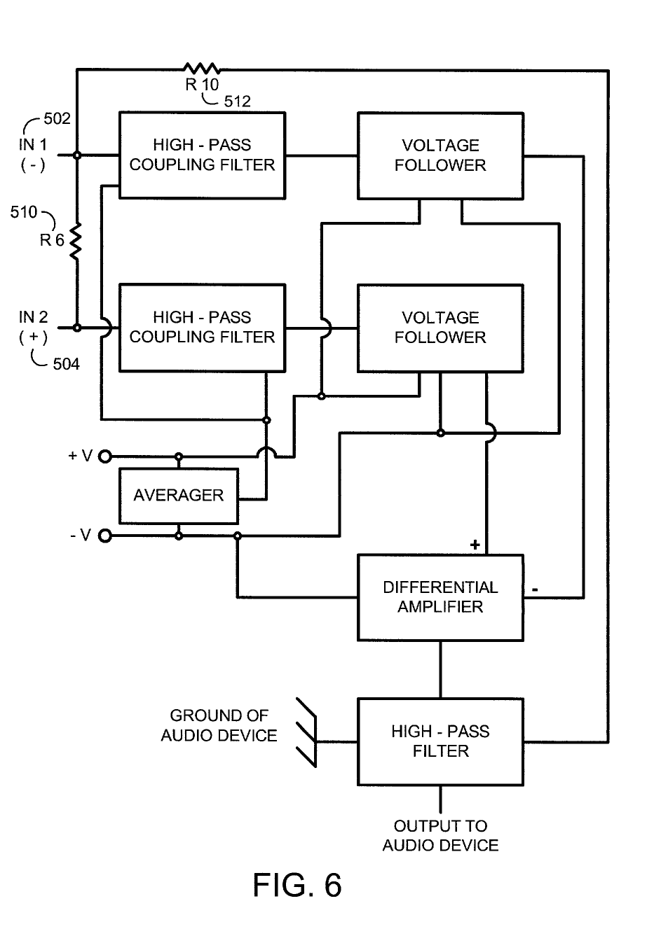

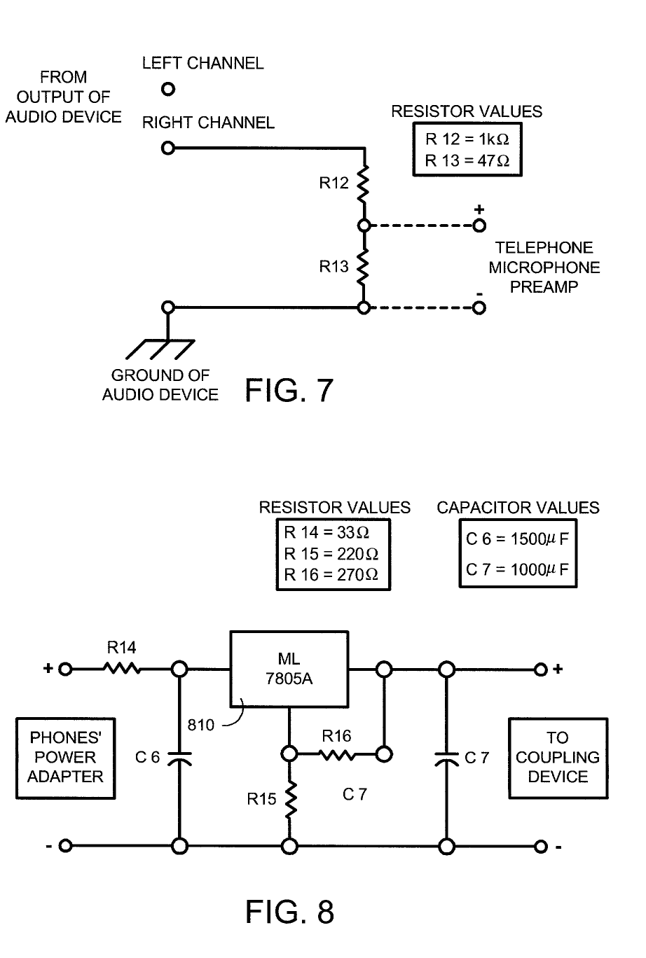

FIGS. 5-8 show diagrams of a working example of a coupling device for the audio output described in FIGS. 1-4 as base line out 105. To achieve the desired connectivity, additional circuitry to the phone to enable desired impedance matching was used. The circuitry of FIGS. 5-8 illustrate just an example to enable the utilization of an existing phone product to act functionally. The circuit is referred to as the “Coupling Device”.

The coupling device allows the speaker driver 193 of the phone to drive the microphone inputs 115 of the computer's sound card. The (35 ohm) speaker of the phone was disconnected to allow easy connection to the coupling device, and a (33 ohm) resistor 510 was added across the differential inputs of the coupling device. This resistor 510 prevents the absence of the speaker from significantly affecting the operation of the speaker driver 193. The coupling device isolates the phone from the sound card 116, attenuates the signal to levels appropriate for the microphone input 115, and was designed so it can use power from the phone.

A voltage divider made from (fixed-value) resistors was used to attenuate the signal from the speaker-out 114 output, of the sound card 116, on its way to the microphone preamplifier of the phone. It was found that the negative terminal of the preamplifier did not need to be connected to this voltage divider because the phone internally connects this negative terminal to one terminal of its speaker driver. Since the coupling device includes a resistor 512 between that terminal of the driver and the ground of the sound card, the needed connection is already (indirectly) supplied.

The voltage divider extends from one of the stereo channels (either the left or the right channel) of the speaker-out jack of the sound card 116 to the ground of the same jack. The other channel is not used. The positive input of the phone's microphone preamplifier is connected to a point between the two resistors of the voltage divider. Thus, the signal from the sound card 116 is attenuated before the preamplifier. The phone internally provides the connection between the negative terminal of the preamplifier and the terminal of the phone's speaker driver that is connected to the In 1 (−) 502 input of the coupling device.

The coupling device was connected, almost directly to the phone's DC power plug. As the DC power provided by the plug was rough a filter was added, and voltage regulated between this plug and the coupling device. The phone may provide filtering and voltage regulation internally and some internal point for powering to the coupling device may be able to be connected. The 33□ohm resistor and the capacitors shown in FIG. 8 provide the filtering. The voltage regulator (for example, it can be ML 7805A) 810 maintains its output at five volts above the regulators reference terminal. Two resistors function as a voltage divider to raise the reference potential about 4.1 volts above the negative terminal so the output is about 9.1 volts above the negative terminal.

The phone's speaker driver 193 is connected to the inputs In 1 (−) 502 and In 2 (+) 504. The resistor R6 510 prevents the absence of the speaker from significantly affecting the operation of the speaker driver. High-pass filters (capacitor C1 514 and, resistor R3 516) filter away DC offsets. The operational amplifiers A1 518 and A2 520 function as voltage followers to provide isolation from the differential amplifier that is at their outputs. This differential amplifier (including A3, 522) actually provides the attenuation down to levels appropriate for the microphone inputs of the sound card 116. The output of this differential amplifier passes through another high-pass filter that provides some isolation from the sound card.

Since three voltages power this coupling device, but the phone provides two voltages, amplifier A4 524 is part of an averager that supplies a middle voltage. Additional capacitors (four of them) are connected to the power inputs to diminish the effects of transients. The example used a quad op amp chip (LM324N) 526 to provide all four operational amplifiers.

The foregoing has described the principles, preferred embodiments and modes of operation of the present invention. However, the invention should not be construed as being limited to the particular embodiments discussed. The above-described embodiments should be regarded as illustrative rather than restrictive, and it should be appreciated that variations may be made in those embodiments by workers skilled in the art without departing from the scope of the present invention as defined by the following claims.

1. A telephony device for providing audio telecommunication, comprising:
a PSTN module that provides communication over a public switched telephone network (PSTN); and
a computer module electronically coupled to the PSTN module and a computer for providing audio communication between the computer and the telephony device.

2. The telephony device of claim 1, further comprising a switch module for selectively coupling the PSTN module to the computer module for enabling simultaneous audio telecommunication between the telephony device and another communication device over at least one of the PSTN or the computer.

3. The telephony device of claim 1, further comprising a paging module coupled to the computer module and the switch module for sending an alert signal when a predefined event occurs.

4. The telephony device of claim 1, further comprising an RF module that allows cordless telecommunication of the telephony device.
